(19) United States
(12) Patent Application Publication
(10) Pub. No.: US 2014/0129543 A1
(43) Pub. Date: May 8, 2014

(54) SEARCH SERVICE INCLUDING INDEXING TEXT CONTAINING NUMBERS IN PART USING ONE OR MORE NUMBER INDEX STRUCTURES

(71) Applicant: MICROSOFT CORPORATION, Redmond, WA (US)

(72) Inventor: Helge Grenager Solheim, Oslo (NO)

(73) Assignee: MICROSOFT CORPORATION, Redmond, WA (US)

(21) Appl. No.: 13/667,593

(22) Filed: Nov. 2, 2012

(51) Int. Cl. G06F 17/30

(52) U.S. Cl. 707/711; 707/741; 707/E17.108; 707/E17.002

(57) ABSTRACT

Embodiments provide indexing and searching features, but are not so limited. In an embodiment, a search service is configured to use one or more separate number index structures as part of providing a rich search service that includes reliable numerical value range searching functionality. A method of an embodiment operates to extract numbers from original strings of electronic documents to provide a list of terms for a main dictionary and a list of numbers for a separate number index structure as part of providing a search service that efficiently indexes text that contains numbers. Other embodiments are included.

### BACKGROUND

Computer users have come to rely on the fairly quick and accurate search results obtained using current state of the art search technologies. Various indexing methods are employed to manage the typically large amounts of information associated with complex computing environments. One current technique involves the use of physical field structures to index one or more item properties as part of providing a full-text index search service. However, many of the current indexing methods result in large data or index structures that require frequent maintenance.

Part of the challenge to provide a reliable indexing method lies in the fact that electronic documents can be large and costly to parse and process when creating a full-text index, due in part to the amount of information required to track aspects of each indexed electronic document. A substantial contributor to the size of a conventional full-text index or dictionary results from the inclusion of numbers. For example, one current technique stores numbers from electronic documents along with metadata when populating a full-text index, where storing of the numbers alone results in the occupying of one (1) byte per digit per number or more of memory. Storing numbers in this manner can result in an inordinately large conventional index structure which can be difficult to manage and maintain. Moreover, due in part to how a full-text index is populated, the current state of search engine services are inefficient when indexing numbers and/or serving queries associated with some range of numbers.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide indexing and searching features, but are not so limited. In an embodiment, a search service is configured to use one or more separate number index structures as part of providing a rich search service that includes reliable numerical value range searching functionality. A method of an embodiment operates to extract numbers from original strings of electronic documents to provide a list of terms for a main dictionary and a list of numbers for a separate number index structure as part of providing a search service that efficiently indexes text that contains numbers. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing environment.

FIG. 2 depicts an exemplary conventional index structure associated with a single document that includes words and numbers.

FIG. 3 depicts an example of a non-numeric index structure and a separate number index structure.

FIG. 4 depicts a tabular example of information associated with a number of exemplary electronic documents.

FIG. 5 depicts an exemplary conventional index structure that includes words and numbers.

FIG. 6 depicts an example of a non-numeric index structure and a separate number index structure.

FIG. 7 depicts a conventional index structure including words, numbers, and positional mapping information.

FIG. 8 depicts an example of a non-numeric index structure and a separate number index structure including positional mapping information.

FIG. 9 depicts an exemplary bitmap representation.

FIG. 10 is a flow diagram depicting an exemplary process of providing indexing and searching operations as part of a searching service.

FIG. 11 is a block diagram depicting components of an exemplary system configured to provide indexing and searching services.

FIG. 12 is a block diagram illustrating an exemplary computing environment for implementation of various embodiments described herein.

### DETAILED DESCRIPTION

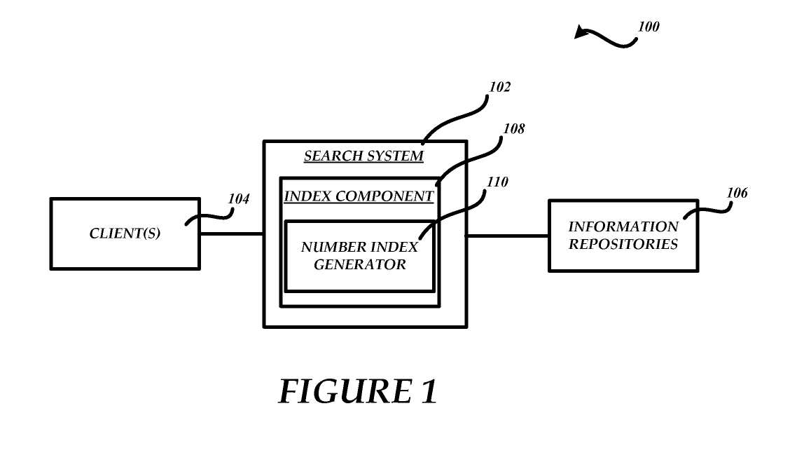

FIG. 1 is a block diagram of an exemplary computing environment 100 that includes processing, memory, and other components/resources that provide search services including the use of indexing, searching, and/or other information processing operations. While FIG. 1 provides a simplified overview of a search service, components of the environment 100 include features and functionalities to provide index structures including one or more separate number index structures. The one or more separate number index structures of an embodiment are maintained apart from a main non-numeric or partially numeric index structure (main index structure). In an embodiment, the distinct number index structure is populated with extracted numbers along with an associated electronic document identifier or identification (e.g., doc ID) and/or a position within an associated electronic document. In one embodiment, extracted numbers are removed from the original string and a modified original string is stored in a main non-numeric or partially numeric index structure. For example, a non-numeric index structure can be populated to not include identified numbers whereas a partially numeric index structure can include strings that include both letters and numbers based in part on an output of an index generation algorithm.

A search service can use a main index structure that utilizes different physical field structures to index each aspect or property of an extracted item. For example, some properties, as well as main document content, are typically indexed as strings (e.g., title, author, etc.). The main index structure can use standard inverted indexing structures with a dictionary and lists of document IDs per word in the dictionary. The main index structure can use other properties such as specialized numerical properties that can be used for other types of searches and can be optimized for certain numerical searches.

As part of creating and maintaining index structures, by automatically extracting numbers from text, the size of a main index dictionary used for full-text searching can be reduced significantly, thereby improving the overall cost and response time (e.g., less disk space and CPU power needed). A separate number index structure provides a variety of numerical search features, including ready processing of numeric range searches. As part of providing an efficient storage mechanism, instead of bloating the standard text dictionary with more or less useful long and accurate numbers, numbers can be stored in a separate numeric index structure to thereby save dictionary space in the main index structure. Additionally, by using a separate number index structure, searches that do not include numbers can be simplified and processed more efficiently.

The separate number index can be provided in part by automatically extracting numbers while scanning text for numbers to identify numbers to be extracted. Due in part to the separate number index, additional query/search functionality can be provided, as described below. The separate number index can be used to provide additional search functionality, namely range searches and fuzzy numerical matching operations as examples. A search service can be implemented to be fully automated, without any configuration required by the end-user or system administrator. Alternatively, the search service can be implemented to be configurable using a schema to provide full control of when to use the separate number or numbers-only index, including configuring the precision of how numbers are stored in the numbers-only index.

As described below, components of an embodiment are used in part to generate and/or maintain index structures including a separate number index that includes extracted numbers from electronic items, including electronic documents, and a mapping of the extracted numbers to one or more associated electronic items. In one embodiment, the number index can be generated to also include positional information that tracks a location or position of each number in a corresponding electronic document or documents. Components of the environment 100 can be configured to perform crawling operations, generate and/or maintain indexing or index structures, and/or serve search queries, but are not so limited.

As shown in FIG. 1, the exemplary environment 100 includes a search engine 102 communicatively coupled to one or more clients 104 and/or one or more information repositories 106. For example, the search engine 102 can be used to search across local computer storage, remote computer storage via a distributed computing network, etc. (including documents in transit) in part by utilizing a number-only index structure. The number-only index structure of an embodiment is configured as a separate numerical index that includes a dictionary of numbers maintained separately from a word index, phrase index, etc. In one embodiment, numbers extracted from electronic documents are stored in a sixty-four (64) bit format to provide a compact and reliable number storing method.

The information repositories 106 are used in part to provide crawled data/information associated with a distributed computer network and associated systems/components, such as site collections, sites, and farm content as a few examples. As to those skilled in the art, the Internet provides an integrated computing network to evaluate content as part of indexing the content in part to provide a reliable and efficient search service. In one embodiment, the environment 100 includes a shared services deployment that can be used to provide a search service including the search engine 102 that uses a separate number index populated with extracted numbers in part to provide number-related searches including numerical range searches.

The index component 108 uses one or more repositories 106 to retrieve, crawl and index information including numbers. The index component 108 of an embodiment includes an indexing model that in addition to generating and using a word and/or phrase index structure, includes a number index generator 110 and a number index generation algorithm that operate to generate the separate number index structure. The separate number index structure of an embodiment includes extracted or identified numbers associated with and/or contained in analyzed electronic documents that may or may not be included in the one or more repositories 106, such as web pages, spreadsheet documents, word processing documents, emails, filenames, etc. The index component 108 includes indexing features that can be configured using a schema in order to control if, how, and/or when a number index is to be generated.

With continuing reference to FIG. 1, the index component 108 can be used to process any number of searchable items including, but not limited to, web pages, emails, documents of any kind, spreadsheets, music files, picture files, video files, contacts, lists and list items, tasks, calendar entries, content of any kind, metadata, meta-metadata, etc. The indexing features of the index component 108 can be used to build language specific and other indexing structures including language specific number indexes during document and other item processing operations. The search engine 102 of one embodiment includes features that operate, but are not so limited, to: create indexes based on raw textual input and/or return results for queries by using the indexes; receive content from various clients, crawlers, connectors, etc. which can be processed and indexed; and/or parse information including electronic documents and other content to produce a textual output, such as a list of properties such as document title, document content, body, locations, size, etc. as examples.

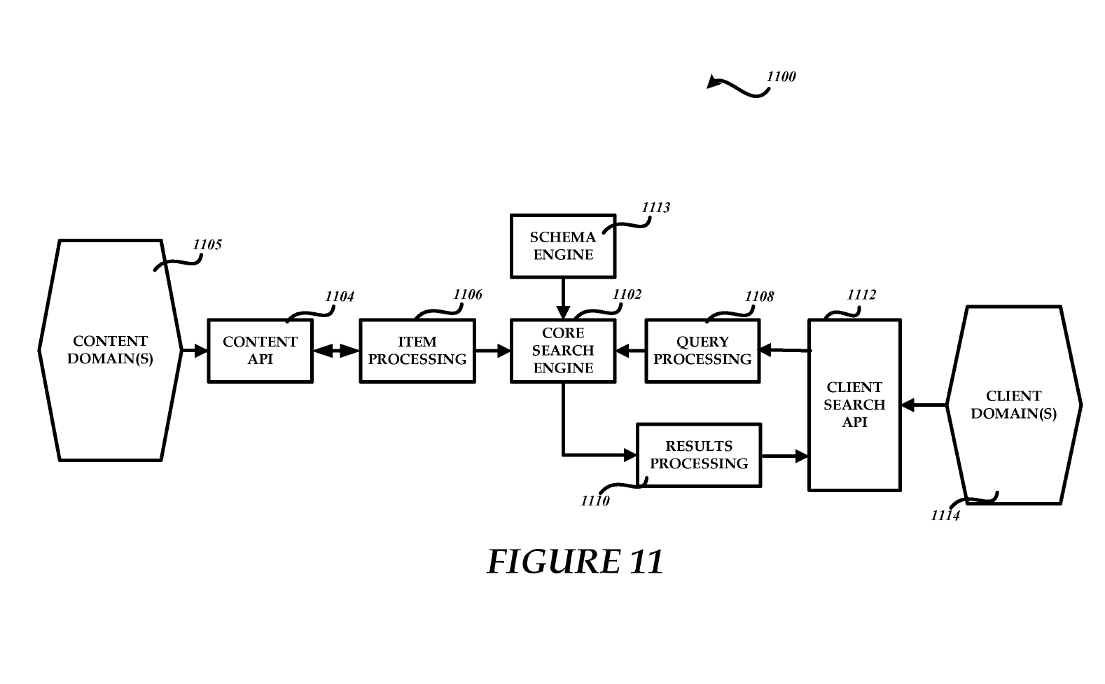

The numerical indexing and search functionality of the search engine 102 enables number-based search operations that can be implemented in various ways. The numerical indexing and search functionality of the search engine 102 of an embodiment can be configured using a plurality of components of a search service. As an implementation example, components such as document processing, query processing, and a schema engine can be used to impart the numerical indexing and search functionality while leaving an existing core search engine unchanged, as described below with respect to FIG. 11.

As described above, a schema can be used to index information associated with electronic documents. For example, textual properties (e.g., the body of the electronic document) can be extracted and/or transformed using a Boolean flag to control which properties to extract. In one embodiment, the number index generator 110 can check an Extract Numbers flag of the schema to determine whether to extract numbers for populating into a separate number index. Other flags can be used by the number index generator 110 to control further transformations on extracted and/or identified numbers, such as reducing precision, etc. Using a schema to control extraction operations alleviates the need to hardcode the number extraction and/or transformation functionality. As an example, a configurable schema architecture can be used to determine how and when to populate a separate number index.

As described briefly above, a number of flags can be used in part to control extraction operations associated with properties or other information of an electronic document. In an embodiment, a number extraction flag can be used in part to control when numbers are to be extracted from electronic documents and/or stored in one or more separate number index structures (e.g., one for decimal numbers, another for integer numbers, another for numbers with punctuation (e.g., social security numbers, account numbers, etc.) etc.). Using an extraction process of a number index generation algorithm in part to build one or more index structures, including one or more of a full-text index structure and one or more number index structures, a search service can operate to parse electronic documents and extract and/or transform textual, numerical, and/or binary properties.

In an embodiment, for every textual property to be extracted using an extract number flag (e.g., ExtractNumbers=true), the search service operates to perform a single scan through a corresponding string, and upon identifying a number, extract the identified number into a separate list of numbers and/or removed from the original string. As a result, the search service operates to modify the original string, remove identified numbers, and/or generate a new list of numbers along with mappings to and/or positional information for parsed electronic items. An efficient storage of an embodiment includes storing the extracted numbers using one or more separate number indexes to compliment a full-text word index.

When searching for a number range according to an embodiment, the search service uses the number index or plurality of number indexes in lieu of an exact text matching process, resulting in higher recall for number-based searches, but is not so limited. Moreover, by using a separate number index structure, the size of a complimenting full-text index can be reduced as compared to conventional methods of storing numbers along with words in a an example of full-text index. The separate number index structure of an embodiment comprises a single multi-valued (or one for integer and one for decimal numbers) index that stores each number using 64-bits or other compressed or non-compressed lossless numerical representations such as but not limited to Huffman encoding, Golomb encoding, Rice encoding, etc. These encodings analyze the actual numbers at hand and find optimal ways of storing the actual numbers with fewer bits. One simple lossless numerical representation to save space is to analyze the numbers and if they all are smaller than the largest 32 bit number then store them all as 32 bits with one additional flag set to signal that this is done.

A full-text index can be generated as a Boolean occurrence index which can be used to answer which document(s) a given word is in and/or a position occurrence index which can be used to answer which document(s) a given word is in, as well as where in the document(s) that word occurs. An exemplary Boolean occurrence index (answering which documents include a given term) is an indexing structure used to find the matching document set for queries with multiple AND and OR operators between terms. The position occurrence index can be used to answer phrase queries. For example, a search for “colonial war” will be translated into a query where a document need not only contain those two words, but the two words must also be in consecutive positions (word counts) in the documents. It is also possible to utilize a phrase index. The position occurrence index can also be used to give rank boosts (“proximity boost”) for words that are very close to each other in documents. For example, a search for two words and/or numbers, may rely on the fact that when the two words that are within a certain distance are more relevant than where they are further apart.

A separate numerical or number index can be isolated and used to answer which document(s) that includes a given value or range of values. In one embodiment, identified and/or extracted numbers are stored in a dictionary portion using a 64-bit format in part to provide a compact and efficient indexing structure. For example, a search service can use one multi-valued number index to track integers and another multi-valued number index to track decimals to provide number range searching and other functionality to end-users, wherein each number can be stored using a 64-bit format.

In one embodiment, each integer number and decimal number is stored using 64-bits for the dictionary portion of each number index. Contrast Unicode implementations where each digit is dealt with separately. For example, a number such as 1234 is represented by four Unicode characters (1, 2, 3 and 4) and not as the number 1234. A binary representation in UTF-8 would use 4 bytes to store 1234 since numbers 0-9 in UTF-8 are stored as 8 bits each (e.g., 00110001 0011010 00110011 00110100). Providing a search dictionary as UTF-16 encoding uses 16 bits per digit and doubles the size used for the numbers. Using a 64-bit numerical representation or format, the number one-thousand, two-hundred and thirty-four (1234) can be stored as:

00000000 00000000 00000000 00000000 00000000 00000000 00000100 11010010.

A larger number such as 123456789012345 can be stored as 64-bits (8 byte) in an integer index but requires 15 bytes in an index dictionary. Space saving can result when not storing position occurrence information, but only Boolean occurrence information for the stored numbers. By storing numbers as real numbers and not just a series of digits, rich range searching functionality is provided by the search service.

When using one or more separate number index structures as part of a searching operation, the search service of an embodiment can process a query and search for numbers in the query only using a separate number index. For example, a query such as and(Reagan,1988) would search for the terms “Reagan” and “1988” in the full text index. However, after a query rewrite operation to use the separate number index, the same query would be written as: And(Reagan,number:1988). Such a query rewrite operation results in the search engine 102 searching for the word “Reagan” in a full-text index and the number “1988” in the associated number index. Number range search operations tend to be more reliable by extracting the numbers in a separate number index. For example, the following query: Near(Reagan, born, and(range(number,1900, 1940))) directs the search engine 102 to search for the words “Reagan” close to “born” and close to a number between 1900 and 1940. Since the query processing uses the separate number index to process the numerical range search, the query processing time can be decreased due in part to the smaller size and ordered consecutive numerical range of extracted number values.

Depending on a configuration type and/or schema setting, the number index can be configured to include or not include position information that identifies where in the document(s) a number or range occurs. Additionally, using a separate number index makes it possible to search for numbers near letters (e.g., near(number:4.3,kg) by storing the position of the number in the original text in the separate number index. In one embodiment, identified numbers can be indexed both in the separate number index and in the full-text index to support normal recall, phrase queries, and/or numeric range queries. It will be appreciated that a number of networking components, including hardware and software, are typically used to provide a robust search service. However, the concepts described herein can also be used as part of a local search service (e.g., application search interface, operating system search interface, etc.).

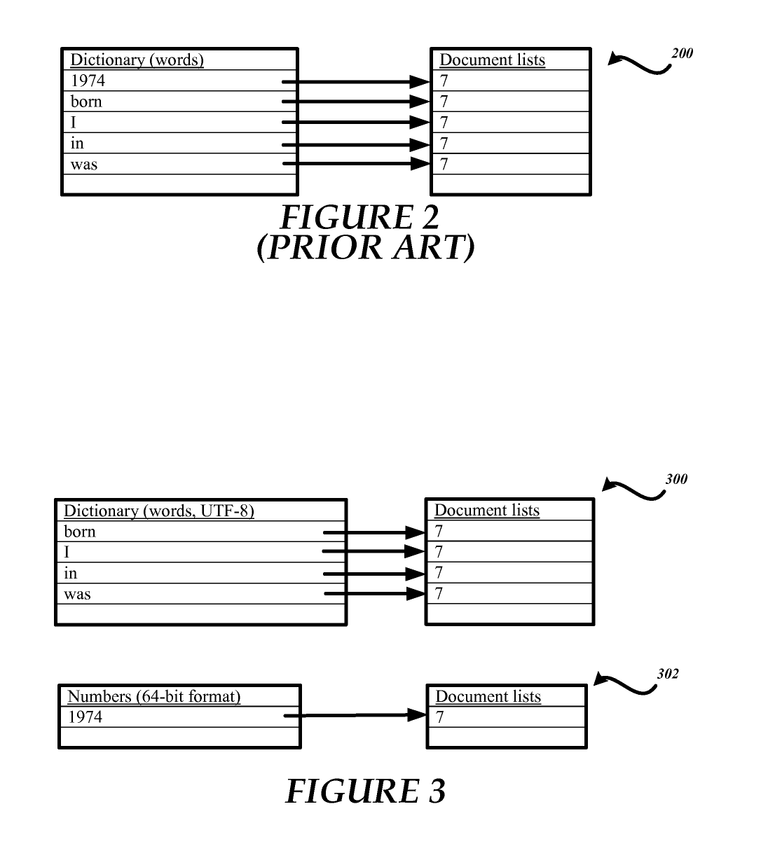

FIG. 2 depicts an exemplary conventional index structure 200 associated with a single document with ID 7 containing the sentence “I was born in 1974” using one full-text index without the use of a separate number index. It will be appreciated that a document or item ID can be used to identify associated electronic documents or other items. As shown, the conventional index structure 200 includes the number one-thousand nine-hundred and seventy-four “1974” as an additional entry with the words in the dictionary list.

FIG. 3 depicts an example of a non-numeric index structure 300 populated with the extracted strings absent identified numbers and a separate number index structure 302 populated with identified numbers using an index generation algorithm of an embodiment. In one embodiment, the index generation algorithm is configured to identify numbers based in part on a language type, encoding type, punctuation, spaces, and/or whether a string being analyzed includes at least one letter or no numbers. The index generation algorithm can operate to identify a string as non-numeric or numeric based in part on whether the string includes at least one letter and/or a space between successive identified numbers.

For this example, the numbers are stored in the separate number index structure 302 in an ascending order which assists with providing quick and reliable numerical value query results, including reliable range search results. As shown, the separate number index structure 302 includes a number list listing the extracted number “1974” along with a mapping to the document with ID 7. For this example, an index generation algorithm operated to remove identified numbers from original strings as part of generating the word dictionary that includes a list of associated words along with doc ID mappings thereto.

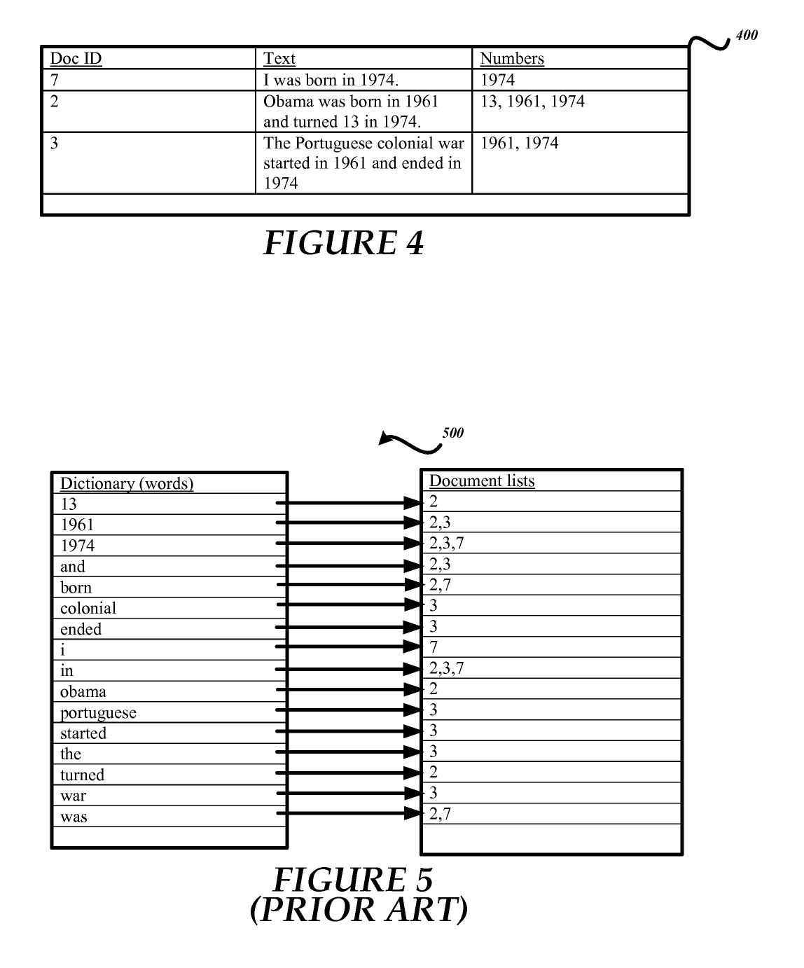

FIG. 4 depicts an exemplary table 400 associated with three electronic documents having IDs of 7, 2, and 3, respectively. The table includes a column pertaining to the words included in each electronic document and another column depicting the numbers associated with the words of each electronic document.

FIG. 5 depicts an exemplary conventional index structure associated with three documents including the word and number mappings to the associated documents without the use of a separate number index.

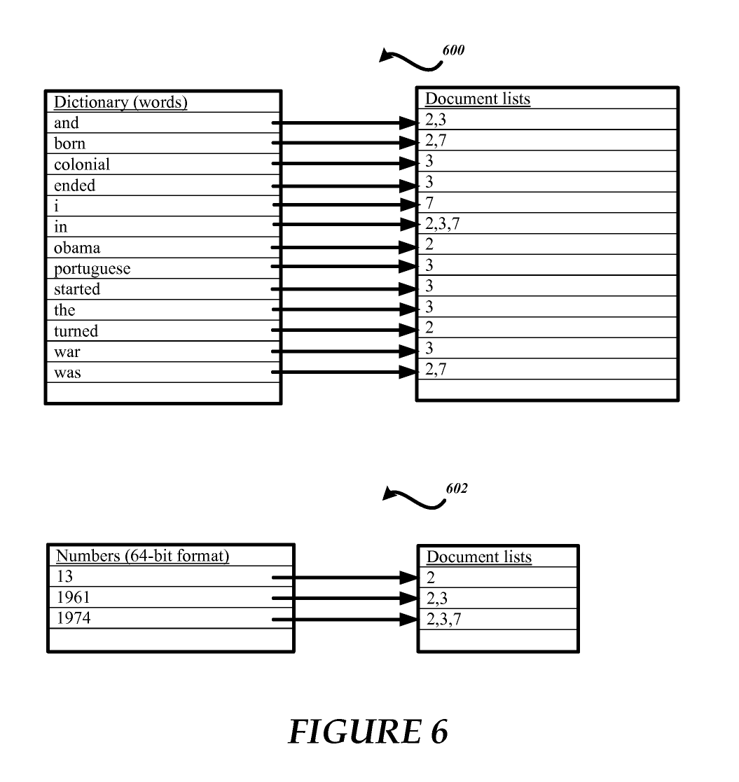

FIG. 6 depicts an example of a non-numeric index structure 600 populated with associated words absent identified numbers and a separate number index structure 602 populated with the identified numbers using an index generation algorithm according to an embodiment. As shown for this example, the numbers are stored in the separate number index 602 in an ascending order. As shown, the separate number index 602 includes a number list listing the extracted number thirteen “13” along with a mapping (shown by directional arrow) to the document with ID 2, the extracted number one-thousand nine-hundred and sixty-one “1961” along with mappings to documents with IDs of 2 and 3, and the extracted number “1974” along with mappings to documents with IDs of 2, 3, and 7. FIG. 6 highlights the fact that storing numbers as 64-bit numbers or some compressed numerical encoding is more compact than storing them as bytes (e.g., UTF-8 encoded, Unicode, etc.). By using the index generation algorithm to extract identified numbers, the number index supports range searches in addition to full-text searching functionality.

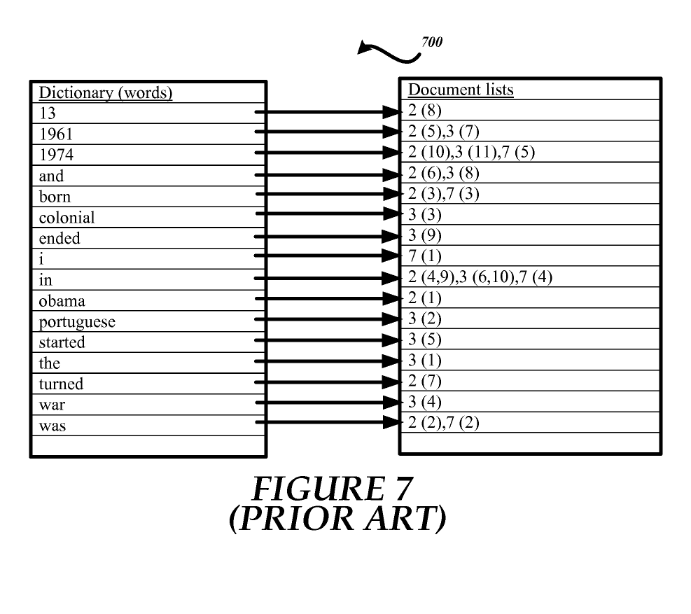

FIG. 7 depicts an exemplary conventional index structure 700 for the three documents including the word and number mappings, and word and number positional information for the associated documents without the use of a separate number index.

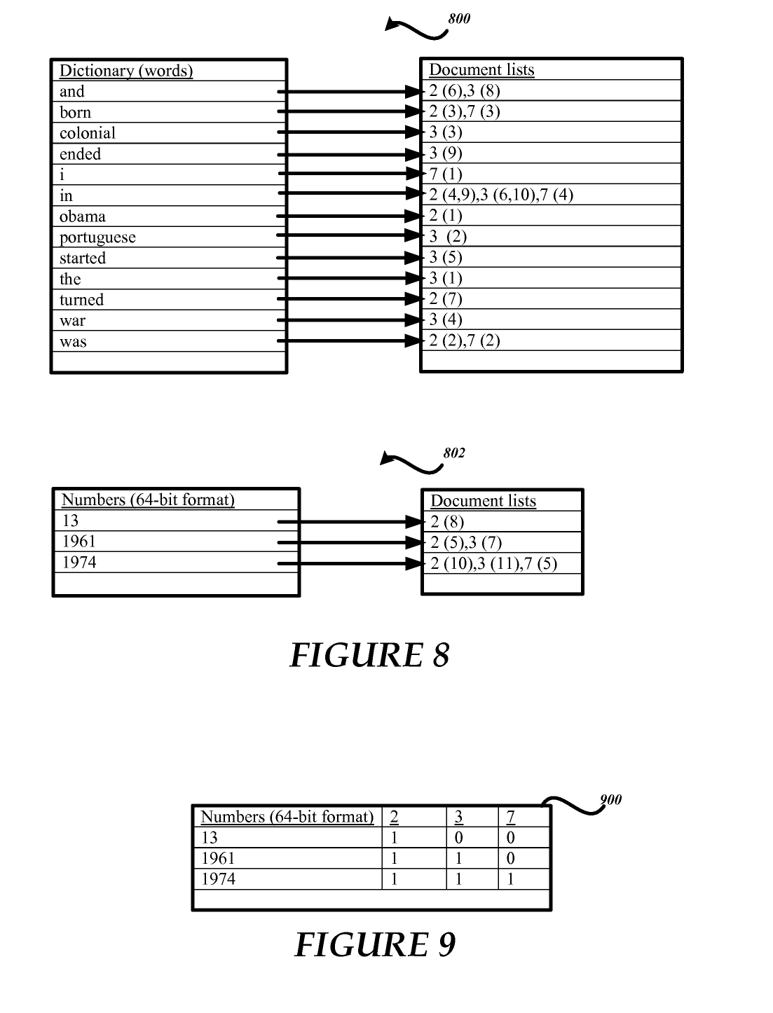

FIG. 8 depicts an example of a non-numeric index structure 800 populated with the associated words and absent numbers, and a separate number index structure 802 populated with numbers and positional information according to an embodiment. For every word in the dictionary there is an associated list of documents, and for each document there is a list with the word locations or positions in the documents. Only the word “in” occurs multiple times in the documents, occurring at position six (6) and ten (10) in document with ID 3, position four (4) and nine (9) in document with ID 2, and position four (4) in document with ID 7.

As shown for this example and according to various embodiments, the numbers are stored in a separate number index 802 in an order, such as ascending order for the example. As shown, the separate number index 802 includes a dictionary listing the extracted number “13” along with a mapping to the document with ID 2 having an associated position eight (8) in the document, the extracted number “1961” along with mappings to documents with IDs of 2 and 3, and having an associated position of five (5) in the document with ID 2 and an associated position of seven (7) in the document with ID 3, and the extracted number “1974” along with mappings to documents with IDs of 2, 3, and 7, and having an associated position of eleven (11) in the document with ID 3, an associated position of seven (7) in the document with ID 2, and an associated position of five (5) in the document with ID 7. FIG. 8 highlights the resulting smaller size of the non-numeric index structure along with the compact number index structure resulting from the use of a 64-bit number storage format. As described above, by using the number index generation algorithm to store extracted numbers, the number index supports range searches in addition to the full-text searching functionality.

Using a separate number index enables efficient number-related searches, including range searches, which tends to reduce overpopulating an associated full-text index. Number indexes can be used to store numbers in a variety of ways, such as, but not limited to: 64-bit numbers—signed or unsigned (unsigned can store 0 and upwards, but can store twice as large numbers); compressed numbers using a variety of compression techniques; decimals—by scaling a number, e.g. multiplying by 100 it is stored internally as a 64-bit integer and then divided by 100 again when returned to the end-user; floating point numbers—include a varying number of digits after the comma and this is stored as part of the number, allowing to store small numbers with large precision and larger numbers with less precision; and/or dates (and dates with/without times)—typically easily converted into integers by assigning an epoch (starting point) which is the minimum date (0), and then using a resolution factor (e.g., a day, a millisecond, etc.) to calculate what integer values other dates transform into. According to various embodiments, a search service can be configured to generate and/or maintain any number of number index types according to a particular implementation.

Using one or more separate number index structures can be used to query for a given range of values and return a list of documents within the queried range. A search service can maintain a plurality of number index structures, each index structure corresponding to a particular numerical data type. For example, a search service can use a plurality of separate number index structures, wherein each number index structure corresponds with an encoding type, transformation type, or other number processing operation.

The following is an example encoding signature used as part of a number range search methodology:

List<DocId> GetDocumentsInRange(int from, int to) // int may be any numerical data type stored. Other encoding signatures can be used according to a particular implementation.

FIG. 9 depicts an exemplary bitmap representation 900 which corresponds with the number index 602 of FIG. 6. In one embodiment, a bitmap representation can be used as part of providing a separate number index. As shown in FIG. 9, the extracted numbers are maintained in an order (e.g., ascending) (also as a separate structure) in the bitmap table. For every number there is a bitmap of 1s and 0s, defining whether a number is included in an associated document. The document IDs have one column each in the bitmap table. It may be appreciated that when there are many numbers and many documents, the bitmap table or structure can include many more 0s than 1s. In such as case, the bitmap table can be compressed for sparsely populated data (for example by instead of listing everything as 1s and 0s, just storing the positions of the is on disk and transforming when loading into memory).

When evaluating ranges using a bitmap structure of an embodiment, bitwise OR or other operations can be used (e.g., XOR/AND depending on the query logic).

As an example, assume a user is searching for documents that contain values >100 and <2000. A search service of an embodiment can be configured to: find all numbers in a given range; iterate through the bitvector of associated documents; and perform a bitwise OR of the documents for every value and store the temporary result. As a result, the numbers 1961 and 1974 would be identified. The number 1961 corresponds with bitvector 110 and the number 1974 corresponds with bitvector 111. Performing a bitwise OR operation using 110 and 111 results in 111. Thus, using bitmap representation 900, the example number range search results in a query result that documents (IDs 2, 3, and 7) are associated with the searched over range. In cases of large ranges, the search service can use bitvectors for larger chunks of data which allows for faster dataset pruning. It is also possible to create bitmaps for ranges of numbers, thus creating hierarchies of existing numbers and making it possible to effectively search for larger ranges without needing to do all the bitwise OR and AND operations. One embodiment could maintain bitmaps for all ranges 0-99, 100-199, 200-299 etc. if range searches typically span a large number of numbers to avoid computing these bitmaps for every range search.

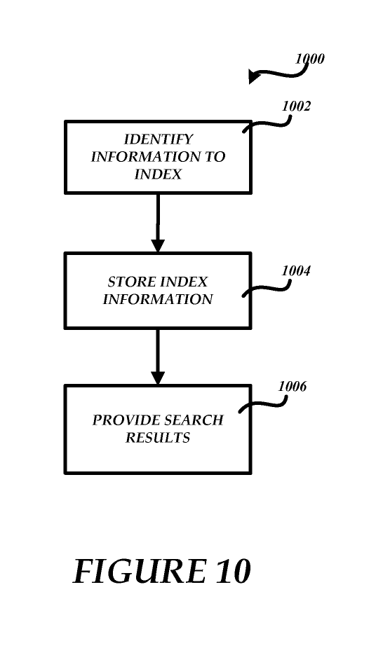

FIG. 10 is a flow diagram depicting an exemplary process 1000 of providing indexing and searching operations as part of a searching service, including using one or more separate or distinct number index structures or number indexes to provide rich number searching functionality, but is not so limited. For example, the process 1000 can be used to generate a separate number index to store extracted numbers, as-is, in a desired order (e.g., ascending, descending) for use by a search engine deployed in a cloud or other networked computer architecture.

The process 1000 at 1002 operates to identify information, including numbers, for indexing. For example, an indexing service can be configured to continuously index new and modified numerical information associated with a networked computing architecture. In one embodiment, the process 1000 at 1002 operates to identify and extract numbers in part to provide a separate number index while crawling web pages, documents, emails, etc. In one embodiment, the process 1000 can also operate to add metadata (e.g., filename, location, URL, title, data, author, number type, etc.), and/or perform parsing operations to extract various types of information based on the type of items associated with one or more properties for each item. The process 1000 at 1002 can use a schema to control when and how number extraction (and/or storage) is to be implemented including the number of separate number index structures to use when indexing (e.g., number index for integer extractions, number index for decimal extractions, number index for SSN extractions, etc.). It is also possible to use a single number index populated with any extracted numbers and use tracking properties for each number or transformation type.

At 1004, the process 1000 operates to store identified information in a plurality of index structures, including at least one number index. As described above, numbers can be identified and stored in a number index along with a mapping to an associated electronic item (e.g., web page, word processing document, spreadsheet document, email, etc.). For example, the process 1000 can be configured to store different types of numbers based in part on a format, encoding, language, and/or some other criteria in a number index. As described above, identified numbers can also be stored in a plurality of number-specific index structures. In various embodiments, the process 1000 can be configured to identify numbers that include a certain defined format including punctuation characters or symbols, but not including letters, such as social security numbers (SSNs), bank account numbers, etc.

In one embodiment, the process 1000 can be configured to run specialized extractors/recognizers and use some general heuristics for clean-up. For example, the process 1000 can be configured to extract certain numbers into associated managed properties by applying a series of regular expressions to recognize number/character patterns. As one example, all identified SSNs are stored using a SSN property and a typed query “SSN:0493049” can be used to locate an associated SSN. In a similar fashion, phone numbers and other special format numbers can be stored using associated managed properties. However, the process 1000 is typically configured to extract numbers with custom extractors but store the extracted numbers in a separate number index as described above.

The heuristics used by the process 1000 of an embodiment can include a number of rules to identify numbers: 1) based on the recognized language, set two variables decimalsymbol=“.” and thousandseparator=“,” (or vice versa which is the case for Norwegian); 2) then, if there is a number listed as NNN,NNN,NNN. (or similar) where NNN is one digit and the digits are grouped 3 and three, then this is considered one number. Similar logic can be used if there are spaces between the commas For this embodiment, if any of the number groups are not three digits, then consider as separate numbers. A space between numbers also can be interpreted as being separate numbers. The process 1000 can also be configured for different contexts, such as allowing for spaces and/or one decimal point for each extracted number.

For example, the process 1000 can be configured to evaluate the following strings according to different numerical extractions:

A) The string “The first 123 is the second” and store the number one-hundred and twenty-three “123” as a number in the number index;

B) The string “The first 123 456 is the second” and store the number one hundred and twenty three-thousand four-hundred and fifty-six “123456” as a single number or one-hundred and twenty-three “123”, and four-hundred and fifty-six “456” as separate entries in the number index;

C) The string “The first 123, 456 is the second” and store the numbers “123456”, “123”, and “456” as separate entries in the number index; and

D) The string “The first 123, 456 and 789 is the second” and store the numbers “123456” as one number, and “789” as another number, and/or also store the three numbers “123”, “456” and “789” in a separate number index.

In certain embodiments, the process 1000 can be configured to extract and/or store multiple number interpretations to provide greater recall for a rich search service. At 1004, the process 1000 operates to store identified and/or extracted numbers in one or more number index structures. It will be appreciated that, in addition to generating at least one separate number index, the process 1000 operates to provide a full-text word and/or phrase or other index structure in part to provide a robust search service. For example, the process 1000 can be used to generate a main non-numeric or partially numeric index structure associated with a number of managed properties. At 1004, the process 1000 of an embodiment can be configured to store indexed information in memory, such as part of dedicated server storage. At 1006, the process 1000 operates to use the stored indexed information to serve queries and provide search results, including number range and other number-based search results using at least one separate number index. While a certain number and order of operations is described for the exemplary flow of FIG. 10, it will be appreciated that other numbers and/or orders can be used according to desired implementations.

FIG. 11 is a block diagram depicting components of an exemplary system 1100 configured to provide indexing and searching services, including using one or more separate non-numeric and number (or numeric) index structures to provide a rich searching functionality, but is not so limited. As shown, the exemplary system 1100 includes a core search engine 1102, a content application programming interface (API) 1104, item processing 1106, query processing 1108, results processing 1110, a client search API 1112, and a schema engine 1113.

It will be appreciated that indexing and searching features of a search service can be implemented as part of a processor-driven computer-implemented environment, such as a plurality of servers and other components that are used to provide a distributed search service. The search service, as part of providing robust search operations and results, can include a computing architecture that uses processor(s), memory, hard drive storage, networking, and/or other components. A computer storage medium or computer storage can be configured with instructions or code that, when executed, uses one or more separate number index structure to provide rich number searching features, including numerical range and other searches. In other embodiments component features can be further combined and/or subdivided.

In an embodiment of the exemplary system 1100, item processing 1106, query processing 1108, and the schema engine 1113 are used in part to generate one or more separate number index structures to use as part of the search service. However, in an alternative embodiment, the core search engine 1102 can be configured with functionality to create indexes based on raw textual input, including generating and providing one or more separate number index structures. The core search engine 1102 can use one or more separate number index structures as part of providing a rich number searching functionality.

The core search engine 1102 of an embodiment interacts with the schema engine 1113 by reading schema information, including reading information associated with how and when numbers are to be extracted from original strings and populated in a separate number index. The schema engine 1113 is used to configure which textual properties (e.g., body) are to be extracted and/or transformed. For example, a Boolean flag can be used for each property to set whether to extract and/or transform an associated property. The schema engine 1113 of one embodiment uses an extract numbers flag to control if and when numbers are to be extracted and/or transformed. Other flags can be implemented to control further transformations to be performed on any identified numbers, such as reducing precision, converting to a whole number, changing sign, changing base, etc. Using a schema and/or schema interface to control number extraction operations results in a programmer not having to hardcode each solution.

The schema engine 1113 provides an interface to a user, system administrator, component, device, system etc. For example, a schema user interface (UI) can be used as part of a web-based or other user interface that uses hypertext markup language (HTML), SILVERLIGHT, AJAX, JAVA, or other coding technologies, a web service interface (e.g., SOAP, WCF, JSON, etc.), or any other remote or local interface through which it is convenient for a user to communicate or interact with the system 1100. The schema UI can be configured to translate user interaction to calls to schema engine 1113 to persist schema information in a schema storage database or other storage.

The content API 1104 is used by various clients, crawlers, connectors, etc. (e.g., content domains or information repositories 1105) to submit and receive content for subsequent processing and indexing operations. Item processing 1106 operates to parse electronic documents and other electronic information in part to produce textual and other output, such as a list of properties for example (e.g., document title, document content, body, locations, size, etc.) and/or a list of extracted numbers that are to be included and/or updated in a separate number index.

Item processing 1106 of one embodiment is configured to parse incoming electronic documents and extract and/or transform textual, numerical, and/or binary properties. For every textual property with an extract numbers flag equal to true, item processing 1106 of an embodiment performs the following operations: a) perform a single scan through each string, b) extract identified numbers into a separate list of numbers, and/or c) remove the identified numbers from the original string, resulting in the original string with all numbers removed along with a new list of identified numbers. As described above, numbers can be identified using various techniques known to those skilled in the art.

Query processing 1108 operates to analyze raw user input (e.g., query), including improving and/or rewriting a query for execution using the core search engine 1102. For example, query processing 1108 can be configured to detect language, correct spelling errors, add synonyms to a query, rewrite abbreviations, search for number ranges, etc. Query processing 1108 of one embodiment operates to process a query with numbers by splitting out the numbers and use the number index for these numbers. In an alternative embodiment, the main index can be also populated with extracted numbers and the main index and separate number index can be used in tandem by query processing 1108.

Results processing 1110 operates to process results provided by the core search engine 1102 before being returned to the end-user. For example, results processing 1110 can include ranking and relevancy determining algorithms or other features used in part to return relevant search results. The client search API 1112 is used by search front-end and other applications (e.g., client domains 1114) to issue queries and retrieve results using the queries.

In one embodiment, the system 1100 can also include an alerting engine that operates to store queries and analyzes all incoming (e.g., crawled or fed) documents. For example, when a new document matches a query, the altering engine can send out an alert to any subscribers of the alert. The exemplary system 1100 can be used to provide rich searching services while at the same time providing a store for domain-wide terms, keywords, content types, and other data. The searching services can be shared and hosted using a distributed computing network.

While certain embodiments are described herein, other embodiments are available, and the described embodiments should not be used to limit the claims. Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is usable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media or computer storage. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

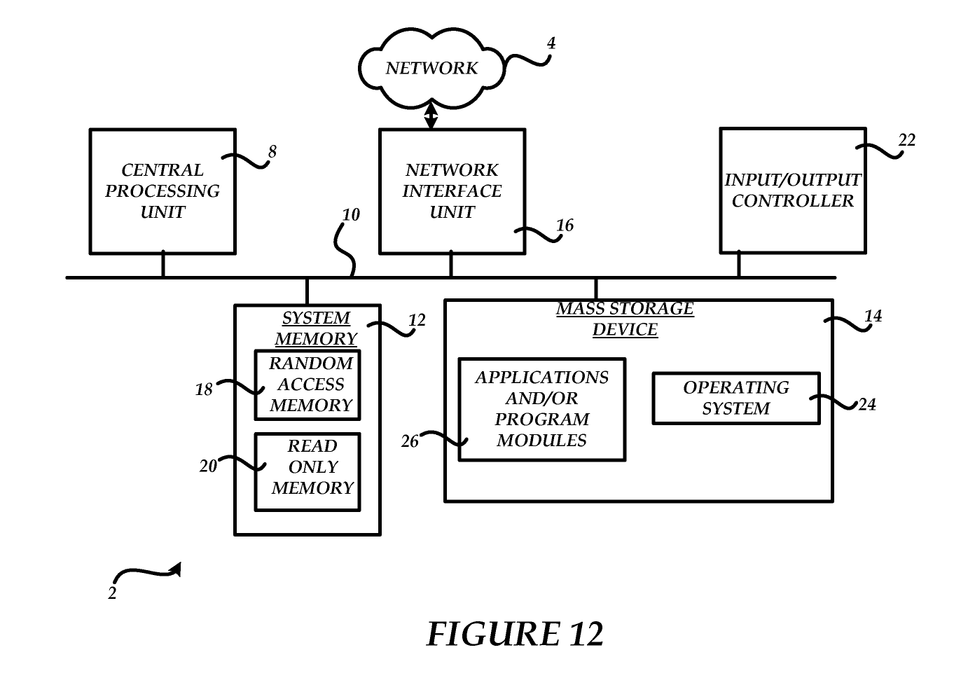

Referring now to FIG. 12, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 12, an illustrative operating environment for embodiments of the invention will be described. As shown in FIG. 12, computer 2 comprises a general purpose server, desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
processing electronic items including identifying numbers included in the electronic items;
extracting identified numbers from the electronic information including electronic items into a number index structure; and
using the number index structure as part of providing a search service that includes numerical range searches.

2. The method of claim 1, further comprising using a main index structure including words and the number index structure as part of searching a range of numbers.

3. The method of claim 2, wherein the number index structure identifies one or more electronic documents that include a given numerical value or range of numerical values.

4. The method of claim 2, wherein the main index structure comprises a Boolean occurrence index that identifies one or more electronic documents that include a particular word or phrase.

5. The method of claim 2, wherein the main index structure further comprises a position occurrence index that identifies one or more electronic items that include a particular word or phrase including a position of the particular word or phrase within the one or more electronic items.

6. The method of claim 1, wherein identifying words and numbers contained in the electronic items includes parsing each electronic item to identify words and numbers using regular expressions.

7. The method of claim 1, further comprising identifying numbers using an index generation algorithm and an extract number flag, and storing each identified number using a sixty-four (64) bit format.

8. The method of claim 1, further comprising serving a query including using the number index structure as part of locating relevant items associated with one or more numbers of the query.

9. The method of claim 1, further comprising generating the number index structure to include a dictionary of numbers based in part on a numerical data type and a schema, generating a separate list of extracted numbers, and removing the numbers from the original string before providing a non-numeric index structure.

10. The method of claim 1, further comprising populating the number index structure such that numbers extracted from one or more electronic documents are mapped to documents lists, including mapping positions of the numbers in each associated document.

11. The method of claim 1, wherein the number index structure further comprises a range of extracted numbers in an order.

12. The method of claim 1, wherein the number index structure further comprises a bitmap structure that maps extracted numbers to associated search items.

13. The method of claim 1, further comprising using a plurality of number index structures, wherein each number index structure corresponds with an encoding type, transformation type, or other number processing operation.

14. A search system comprising:
a search server that uses:
a non-numeric index to store textual strings including one or more identified words absent identified numeric strings; and
a numeric index to store the identified numeric strings, wherein each stored numeric string is based on an index generation algorithm that requires each stored numeric string to only include numeric digits including one or more punctuation characters and absent letters.

15. The system of claim 14, the search server further configured to use the index generation algorithm and a number of regular expressions to store numeric strings in the numeric index based in part on whether a particular string includes numbers separated by a punctuation character and does not include one of a letter or a space.

16. The system of claim 14, further comprising maintaining the numeric index in part using a bitmap structure.

17. The system of claim 14, wherein the non-numeric index or the numeric index includes one of a Boolean and a positional occurrence index.

18. A search engine to provide search services and configured with at least one processor to:
process electronic documents including using one or more index structures including a first index structure and a second index structure to maintain information associated with the electronic documents;
store one or more non-numeric characters and an identification of one or more electronic documents associated with the one or more non-numeric characters in the first index structure;
store one or more numbers and an identification of one or more electronic documents associated with the one or more numbers in the second index structure; and
use the first index structure and the second index structure in part to provide the search services.

19. The search engine of claim 18, further configured to use the second index structure to store the one or more numbers, the identification of one or more electronic documents, and a position of the one or more numbers in the one or more electronic documents.

20. The search engine of claim 18, further configured to use the first index structure to store the one or more non-numeric characters, the identification of one or more electronic documents, and a position of the one or more non-numeric characters in the one or more electronic documents.
